(19) United States
(12) Patent Application Publication
(10) Pub. No.: US 2025/0167712 A1
(43) Pub. Date: May 22, 2025

(54) Dual-Stage BLDC

(71) Applicant: Liam Rhys Charles Bryant-Thomas, Rancho Santa Fe, CA (US)

(72) Inventor: Liam Rhys Charles Bryant-Thomas, Rancho Santa Fe, CA (US)

(21) Appl. No.: 18/952,801

(22) Filed: Nov. 19, 2024

Related U.S. Application Data
(60) Provisional application No. 63/601,083, filed on Nov. 20, 2023.

(51) Int. Cl. H02P 25/18

(52) U.S. Cl. CPC H02P 25/184; H02P 2207/055

(57) ABSTRACT

A device comprising a housing with a stator and an internally positioned rotor mounted on a shaft attached to the housing. The rotor, equipped with multiple magnets, interacts with coil sets wound around the stator. These coil sets connect to a controller that manages the rotor's speed and torque. The device includes switches between the controller and coil sets, enabling activation or deactivation of additional wires within the coil sets to modify the motor's Kv value. The switches, which may be mechanical relays, electronic, or physical, are structured in three stages to allow precise performance control. This configuration supports versatile and efficient operation across various applications.

### FIELD OF THE INVENTION

The present invention generally relates to the field of motor technology. More specifically, the present invention involves a dual-stage Brushless Direct Current (BLDC) motor.

### BACKGROUND OF THE INVENTION

The demand for dual-stage Brushless Direct Current (BLDC) motors is increasing in the industry. BLDC motors effectively mitigate the drawbacks associated with conventional DC motors by eliminating the mechanical contact between the commutator and brushes. This advancement is achieved through the implementation of an electronic commutator, which significantly enhances the reliability and longevity of the motor by minimizing wear and tear.

BLDC motors not only preserve the advantages inherent to traditional DC motors, such as precise speed control and high efficiency, but they also offer benefits typically associated with AC motors, including a simplified structure and reliable operation.

Various types of BLDC motors are available, each offering distinct advantages. For example, single-phase BLDC motors are recognized for their extended lifespan, rapid acceleration, and straightforward design. Despite these benefits, there remains a persistent need for further advancements in BLDC motor design.

The present invention seeks to address the shortcomings of existing systems and methods by delivering substantial improvements in BLDC motor technology. These enhancements are directed towards increasing power density, maintaining consistent torque across varying speed levels, and achieving higher overall efficiency.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a Dual-Stage Brushless DC (BLDC) motor designed to optimize performance through a strategic configuration of its components.

The device comprises a housing with a stator and an internally positioned rotor mounted on a shaft. The rotor, equipped with multiple magnets, is surrounded by coil sets wound around the stator. These coil sets are connected to a controller that manages the rotor's rotational speed and torque, ensuring efficient operation.

A distinctive feature of this Dual-Stage BLDC motor is the inclusion of a series of switches located between the controller and the coil sets. These switches can activate or deactivate additional wires within the coil sets, thereby altering the motor's Kv value. This dual-stage capability allows the motor to adapt its performance to varying operational requirements, providing enhanced flexibility and efficiency.

The switches may be implemented as mechanical relays, electronic switches, or physical switches, and are designed with three stages to enable precise control over the motor's characteristics. This innovative design supports a wide range of applications, offering superior versatility and performance optimization

### BRIEF DESCRIPTION OF THE DRAWINGS

FIG. 1 is an illustration of one embodiment of the present invention.

FIG. 2 is an illustration of one embodiment of the present invention, showing the stator and rotor.

FIG. 3 is an illustration of one embodiment of the present invention showing the stator and rotor placed outside of the stator.

FIG. 4 is an illustration of an alternative embodiment of the present invention showing the stator and rotor placed inside of the stator.

FIG. 5 is an illustration of one embodiment of the present invention, showing the housing cover, rotor, stator, housing support with a shaft.

FIG. 6 is an illustration of one embodiment of the present invention showing the motor device connected to a switch and a controller.

### DETAIL DESCRIPTIONS OF THE INVENTION

All illustrations of the drawings are for the purpose of describing selected versions of the present invention and are not intended to limit the scope of the present invention.

As a preliminary matter, it will be readily understood by those having ordinary skill in the relevant art that the present disclosure has broad utility and application. It should be understood that any embodiment may incorporate one or a plurality of the above-disclosed aspects of the disclosure and may further incorporate one or a plurality of the above-disclosed features. Furthermore, any embodiment discussed and identified as being “preferred” is considered to be part of the best mode contemplated for carrying out the embodiments of the present disclosure. Other embodiments may also be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail concerning one or more embodiments, it is to be understood that this disclosure is illustrative and exemplary of the present disclosure and is made merely for the purposes of providing a full and enabling disclosure. The detailed disclosure herein of one or more embodiments is not intended, nor is it to be construed, to limit the scope of patent protection afforded in any claim of a patent issuing herefrom, which scope is to be defined by the claims and the equivalents thereof. It is not intended that the scope of patent protection be defined by reading into any claim limitation found herein and/or issuing herefrom that does not explicitly appear in the claim itself.

Thus, for example, any sequence(s) and/or temporal order of steps of various processes or methods described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods may generally be carried out in various sequences and orders while still falling within the scope of the present disclosure. Accordingly, it is intended that the scope of patent protection is to be defined by the issued claim(s) rather than the description set forth herein.

Additionally, it is important to note that each term used herein refers to what an ordinary artisan would understand such term to mean based on its contextual use herein. To the extent that the meaning of a term used herein—as understood by the ordinary artisan based on its contextual use—differs in any way from any particular dictionary definition, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing herefrom. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of methods, systems, apparatuses, and devices for Brushless DC (BLDC) motor configurations and operations, embodiments of the present disclosure are not limited to use only in this context.

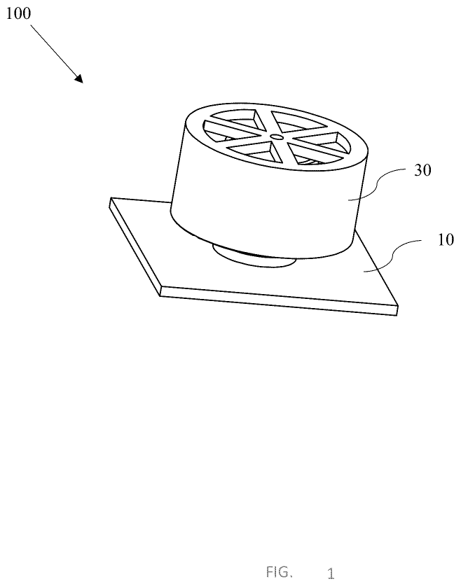

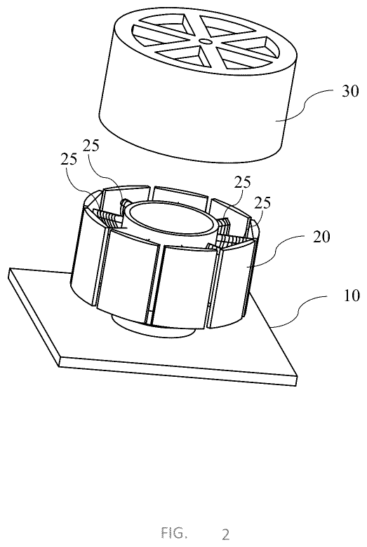

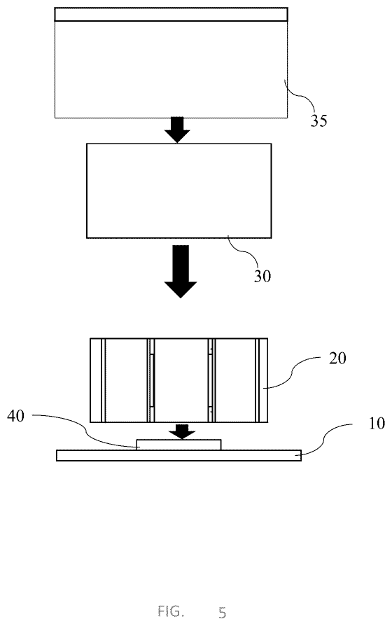

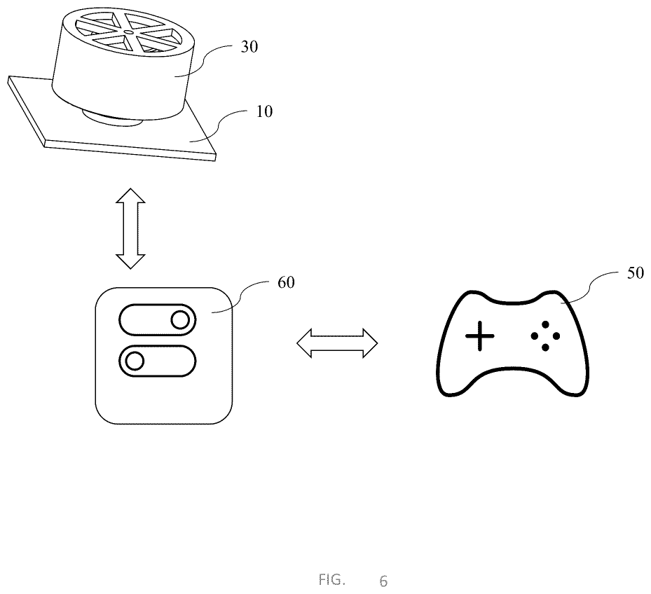

The present invention provides a dual-stage Brushless DC (BLDC) motor 100 that includes components such as a stator 20, rotor 30, magnets 27, coil sets 25, and switches 60, as illustrated in FIGS. 1-6. In some embodiments, the present invention may also incorporate additional components, including circuitry/a controller 50.

### Stator 20

The stator 20 is the stationary part of the motor and, in some embodiment, may serve as the housing 35 (or may have a separate housing (cover) 35 or a housing support 10) for the motor's windings. It is responsible for creating a rotating magnetic field when electrical current passes through its windings.

In one embodiment, the stator 20 may feature trapezoidal windings, which are common in BLDC motors for their simplicity and cost-effectiveness. Alternatively, the stator could utilize sinusoidal windings, offering smoother operation and being preferable in precision applications.

The stator 20 can be mounted securely to the motor housing 35, providing a stable structure for the motor's operation.

In a preferred embodiment, the stator 20 is designed to accommodate both winding types, providing versatility in motor performance.

### Rotor 30

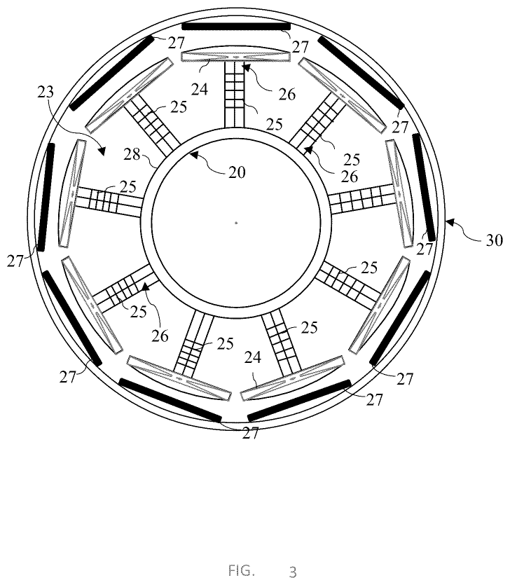

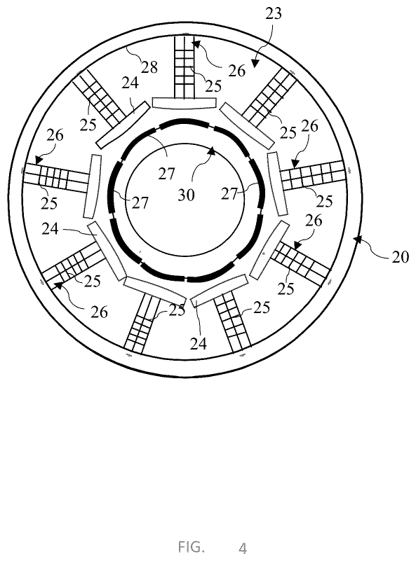

The rotor 30 is the rotating component of the motor, situated inside/outside the stator 20 as shown in FIG. 3 and FIG. 4. It is equipped with magnets 27 that interact with the magnetic field generated by the stator's windings, causing the rotor 30 to turn. The rotor 30 may be configured as either an outrunner (FIG. 3), where the stator is surrounded by the rotor 30 to provide higher torque at lower speeds, or an inrunner (FIG. 4), where the rotor 30 is surrounded by the stator 20, offering higher speeds and efficiency.

A preferred embodiment features an axial configuration, which is compact and suitable for space-constrained applications.

### Magnets 27

Magnets 27 are crucial for the operation of the BLDC motor, as they provide the necessary magnetic field for rotor movement.

In one embodiment, the motor may use ferrite magnets, which are cost-effective and provide adequate performance for general applications. Alternatively, neodymium magnets could be employed for their superior magnetic strength, enhancing the motor's efficiency and power output.

These magnets can be attached to the rotor 30 using adhesive bonding, mechanical fastening, or by embedding them into the rotor material.

In a preferred embodiment, magnets 25 are arranged in multiple pole pairs to increase torque production.

### Coil Sets 25

The coil sets 25 are integral to generating the electromagnetic field that interacts with the rotor's magnets 27. They can be configured in a delta connection for high-speed applications or a star (Y) connection to provide better torque at lower speeds.

In one embodiment, the device 100 may include a plurality of coil sets that includes at least one wire wound on the plurality of poles 26 (the wall of the stator slot 23 between the teeth 24 and the stator circular body/ring 28) forming a plurality of phases in a delta or a wye (Y) configuration;

The coil sets 25 are typically wound around the wall of the stator slot 23 and secured using insulation materials to prevent electrical shorting. Stator slots 23 can be grooves/or space cut into the stator 20 to securely house the windings, influencing the machine's magnetic field distribution, efficiency, and noise levels.

In a preferred embodiment, the coil sets 25 are designed to switch between delta and star configurations, optimizing performance across a range of speeds.

### Switches 60 and Kv Value System

The present invention features a unique Kv value switching system that allows the motor to operate efficiently in both low-speed and high-speed modes.

Kv, or the motor velocity constant, is a measure of how many revolutions per minute (RPM) the motor will turn per volt of electricity supplied, without any load.

A higher Kv value indicates that the motor will spin faster per volt, which is ideal for applications requiring high speed but less torque. Conversely, a lower Kv value means the motor will spin slower per volt, providing more torque, which is beneficial for applications requiring more power at lower speeds.

The Kv value system includes additional wires in each of the motor's stages, which can be activated or deactivated through various switches, such as magnetic relays or electronic switches like MOSFETs or IGBTs or physical switches.

In one embodiment, the device 100 of the present invention may include the plurality of switches 60 with three stages.

These switches 60 can be mounted on a circuit board, which is connected to the motor's electronic speed controller (ESC) 50.

In some embodiments, the device may include a sophisticated motor controller capable of adjusting the voltage and current supplied to the motor windings, effectively changing the Kv value.

When activated, the additional wires increase the Kv value, providing more high-end speed and less low-end torque. Conversely, deactivating these wires lowers the Kv, resulting in more low-end torque but less high-end speed.

In a preferred embodiment, switches 60 are integrated into a controller (or a smart controller) 50, allowing for dynamic adjustment of motor parameters based on real-time feedback. This configuration enhances the motor's versatility and performance, enabling it to be tailored for specific applications.

In one embodiment, the present invention provides a device 100 comprising: a housing 35; a stator 20 having a plurality of teeth 24 and a plurality of poles 26, the stator 20 is mounted to the housing 35; a rotor 30 rotatably arranged inside/outside the stator 20, the rotor 30 is mounted on a shaft 40 attached to the housing 35; a plurality of magnets 27 attached to the rotor 30; and a plurality of coil sets 25 wound around the stator 20.

In such embodiments, the plurality of coil sets 25 can be connected to the controller 50 configured to control rotational speed and torque of the rotor. The plurality of switches 60 can be placed in between the controller 50 and the plurality of coil sets 25, wherein the plurality of switches 60 are configured to activate or deactivate additional wires in the plurality of coil sets 25, altering the Kv value.

Although the invention has been explained in relation to its preferred embodiment, it is to be understood that many other possible modifications and variations can be made without departing from the spirit and scope of the invention.

What is claimed is:

1. A device comprising:
a housing;
a stator having a plurality of teeth and a plurality of poles, the stator is mounted to the housing;
a rotor rotatably arranged inside the stator, the rotor is mounted on a shaft attached to the housing;
a plurality of magnets attached to the rotor;
a plurality of coil sets that includes at least one wire wound on the plurality of poles forming a plurality of stages in a delta or a wye configuration; and
a controller connected to the plurality of coil sets, wherein the controller is configured to control Kv values.

2. The device as claimed in claim 1, wherein the controller are configured to control rotational speed and torque of the rotor.

3. The device as claimed in claim 2, further includes a plurality of switches placed in between the controller and the plurality of coil sets, wherein the plurality of switches are configured to activate or deactivate additional wires in the plurality of coil sets, altering the Kv value.

4. The device as claimed in claim 3, wherein the plurality of switches are mechanical relays.

5. The device as claimed in claim 3, wherein the plurality of switches are electronic switches.

6. The device as claimed in claim 3, wherein the plurality of switches are physical switches.

7. The device as claimed in claim 3, wherein the plurality of switches includes three stages.

8. A device comprising:
a housing;
a stator having a plurality of teeth and a plurality of poles, the stator mounted to the housing;
a rotor having a shaft, rotatably arranged outside the stator, the rotor is mounted on a shaft attached to the housing;
a plurality of magnets attached to the rotor; and
a plurality of coil sets that includes at least one wire wound on the plurality of poles forming a plurality of stages in a delta or a wye configuration.

9. The device as claimed in claim 8, further includes a controller and the plurality of coil sets are connected to the controller configured to control rotational speed and torque of the rotor.

10. The device as claimed in claim 9, further includes a plurality of switches placed in between the controller and the plurality of coil sets, wherein the plurality of switches are configured to activate or deactivate additional wires in the plurality of coil sets, altering the Kv value.

11. The device as claimed in claim 10, wherein the plurality of switches are mechanical relays.

12. The device as claimed in claim 10, wherein the plurality of switches are electronic switches.

13. The device as claimed in claim 10, wherein the plurality of switches are physical switches.

14. The device as claimed in claim 10, wherein the plurality of switches includes three stages.

15. A device comprising:
a housing;
a stator having a plurality of poles, the stator mounted to the housing;
a rotor having a shaft, rotatably arranged outside the stator, the rotor is mounted on a shaft attached to the housing;
a plurality of magnets attached to the rotor;
three coil sets having one or more additional wires, wherein the three coil sets include at least one wire wound on the plurality of poles forming a plurality of stages in a delta or a wye configuration; and
a controller connected to the plurality of coil sets.

16. The device as claimed in claim 15, further includes a plurality of switches placed in between the controller and the plurality of coil sets, wherein the plurality of switches are configured to activate or deactivate the one or more additional wires in the three coil sets, altering the Kv value.

17. The device as claimed in claim 16, wherein the plurality of switches are mechanical relays.

18. The device as claimed in claim 17, wherein the plurality of switches are electronic switches.

19. The device as claimed in claim 17, wherein the plurality of switches are physical switches.

20. The device as claimed in claim 16, wherein the plurality of switches includes three stages.
